(19) United States
(12) Patent Application Publication
(10) Pub. No.: US 2013/0038712 A1
(43) Pub. Date: Feb. 14, 2013

(54) DEVICE FOR DISPLAYING INFORMATION ON THE WINDSCREEN OF AN AUTOMOBILE

(71) Applicant: Patrick Valaix, Meudon (FR)

(72) Inventor: Patrick Valaix, Meudon (FR)

(73) Assignee: PEUGEOT CITROEN AUTOMOBILES SA, Velizy Villacoublay (FR)

(21) Appl. No.: 13/522,238

(22) PCT Filed: Dec. 20, 2010
(86) PCT No.: PCT/FR2010/052826

§ 371 Date: Oct. 31, 2012

(30) Foreign Application Priority Data
Jan. 29, 2010 (FR) 1050652

(51) Int. Cl. B60Q 1/00; H04N 7/18

(52) U.S. Cl. 348/77; 340/425.5; 348/E07.085

(57) ABSTRACT

The invention relates to a driving aid system incorporated into a vehicle comprising a windshield, the system comprising visual information that is not visible, disposed at several predefined locations on the windshield and a lighting device able to illuminate each of the predefined locations so as to cause the appearance thereat of the corresponding visual information in the field of vision of the driver. The visual information comprises at least a first group of identical information, and the system further comprises a unit for detecting the ocular point of the driver providing directional information to the light device which is adjusted so as to illuminate, depending on the directional information received, the predefined location of one of the items of information of the first group, situated in correspondence with the ocular point of the driver detected.

### CROSS-REFERENCE TO RELATED APPLICATIONS

This application is a National Stage Application of International Application No. PCT/FR2010/052826, filed Dec. 20, 2010, which claims priority to French application 1050652, filed on Jan. 29, 2010, the content of which (text, drawings and claims) is incorporated herein by reference.

### FIELD

The present invention relates in general to a driving assistance system incorporated in a vehicle equipped with a windshield, and more in particular a driving assistance system comprising non-visible visual information, supported by the windshield of the vehicle and a lighting device for illuminating this visual information and displaying it in the driver's field of view.

### BACKGROUND

Driving assistance functions are used more and more in the domain of automobiles. Their goal is to assist the driver in the performance of his driving task. They are in general associated with feedback of sound, visual or tactile information. Numerous visual alerts can cause a mental load for the driver, which is contrary to the assistance notion of a driving assistance function.

The concept of enhanced reality, superimposing the information to the actual scene, is a means for improving the ergonomics and the intuitivity of information feedback. In this way the superposition of information to the road scene seen by the user through his windshield represents a benefit.

Current devices, such as head-up vision types starting from displays projected on the windshield or towards a transparent foil, allow for displaying information in the vision field of the driver, but on a limited surface of the windshield.

French document FR 2 926 520, discloses a driving assistance system incorporated in a vehicle comprising a windshield 1, whereby the system comprises non-visible visual information 2, 3, 4 supported by the windshield and a lighting device for this visual information in order to display the information in the vision field of the driver. The visual information is located in several predefined places 5a-5f on the windshield and the lighting device comprises a light source coupled to a directional control mechanism of the light beam emitted by the light source, so that it can sweep over the windshield and light each predefined location under a predefined angle.

This kind of driving assistance system is not taking into account the effective position of the driver's head and therefore the ocular point of the driver. Parallax problems can occur depending on the size of the driver. Indeed, based on the size of the driver and the predefined locations of the pictograms, the information displayed on the windshield may require the driver to divert his eyes from the road scene in order to view the information. For instance, if the driver is tall and alarm information is displayed signaling a pedestrian immediately to his left, there is a risk that the displayed information will not correspond with the detected obstacle.

Numerous visualization systems are known, for instance from document FR 2 864 311, comprising a visualization unit displaying information in a zone of the windshield as a function of the detection result of the ocular point of the driver. This type of visualization system is based on the adjustment of an optical device, starting from a measurement of the driver's eye point. After adjustment, the optical device projects an image in the desired location of the windshield.

This kind of visualization system proves to be expensive and unfortunately incompatible with a driving assistance system as described in document FR 2 926 520, to the extent that this system is based uniquely on illuminating a predefined location of the windshield, containing the pictogram to be displayed, without image projection by an optical device. It is clear that it is not possible to provide a visualization system as presented in document FR 2 864 311 in a driving assistance system as presented in document FR 2 926 520, without losing the advantages of one or the other of the two systems.

### SUMMARY

One goal of the present invention is to overcome the different disadvantages of the above-mentioned prior art and in particular, to provide an inexpensive driving assistance system which displays luminous pictograms, with predefined forms and locations, on the whole surface of the windshield in correlation with the ocular point of the driver.

To this end, a first aspect of the invention relates to a driving assistance system incorporated in a vehicle comprising a windshield, whereby the system comprises non-visible visual images, disposed in several predefined locations on the windshield and a lighting device suitable for illuminating each of the predefined locations in order to display the corresponding visual information in the vision field of the driver. Furthermore, the visual information comprises at least a first group of identical information, and the system comprises a detection unit for the ocular point of the driver supplying directional information to the lighting device, which is adjusted to illuminate, based on the received directional information, the predefined location of one information of the first group, situated in correspondence with the detected ocular point of the driver. This type of driving assistance system provides visual indications to the driver so that the driver does not have to divert his eyes from the road scene, while using a simple and inexpensive lighting device without projection of images.

The form and the contour of the various visual information, disposed in the different predefined locations, are formed on the windshield itself. Each visual information is predefined on the windshield itself, at least in form and contour.

According to various embodiments, the first group of identical information comprises at least two identical pieces of visual information arranged one under the other. Advantageously, the first group of identical information comprises at least three pictograms, an upper pictogram, a median pictogram and a lower pictogram, arranged one above the other. The detection unit for the ocular point of the driver supplies high, median, low directional information, whereby the lighting device illuminates respectively the upper, median or lower pictogram. In this way, the lighting device can select, among the desired identical pieces of information of the first group, the information with predefined location nearest to the ocular point of the driver.

With the goal of covering a majority of people, according to other embodiments, the upper pictogram is located in the 95th percentile of the driver's ocular point, the median pictogram in the 50th percentile and the lower pictogram in the 5th percentile, so that they correspond with tall people (upper pictogram), average size people (median pictogram) and small people (lower pictogram), while avoiding overlap of these pictogram locations on the windshield, ensuring their perfect legibility.

According to various embodiments, the detection unit of the ocular point of the driver supplies directional information based on the height adjustment of the driver's seat. Through the height adjustment of the seat, the driving assistance system can determine at low cost the approximate size of the driver. In this way, a seat adjusted high corresponds with a small person and a low adjustment with a tall person.

According to various embodiments, the detection unit of the ocular point of the driver comprises a camera for detecting the ocular point of the driver on the basis of an image taken by the camera. With the use of a camera, the effective position of the ocular point of the driver can be found. The detection can however be done at lower cost when it is combined with information groups consisting of three pictograms, to the extent that in this case the camera must supply a simple indication corresponding with the three main categories of people sizes, large, average and small. Advantageously, the camera is placed in the upper part of the steering column of the vehicle in order not to obstruct or restrict the vision field of the driver, in particular by positioning the camera on the dashboard or near the central rear view mirror.

According to other embodiments, the ocular point detection unit supplies right or left directional information based on the forward/backward adjustment of the seat. In order to reduce parallax effects, in case of an alert to be displayed on the sides of the windshield, it is advantageous to detect also the positioning of the driver relative to the windshield through the intermediary of the forward/backward adjustment of the seat. Advantageously, the visual information comprises at least a second group of information decentralized on the windshield, comprising at least two pictograms on the same horizontal line, whereby the lighting device illuminates the pictogram corresponding with the right or left directional information.

According to a second aspect, the present invention relates to an automotive vehicle equipped with a driving assistance system according to the first aspect of the invention.

### DRAWINGS

Other characteristics and advantages of the present invention will appear more clearly by reading the following detailed description of the various embodiments of the invention, provided as examples which are in no way limiting and illustrated by the attached drawing.

Figure is a schematic view of a windshield suitable for a driving assistance system according to prior art.

FIG. 2 is a schematic view of a windshield suitable for a driving assistance system according to various embodiments of the present invention.

FIG. 3 is a schematic cross section view of the cabin of an automotive vehicle equipped with a driving assistance system according to various embodiments of the invention.

### DETAILED DESCRIPTION

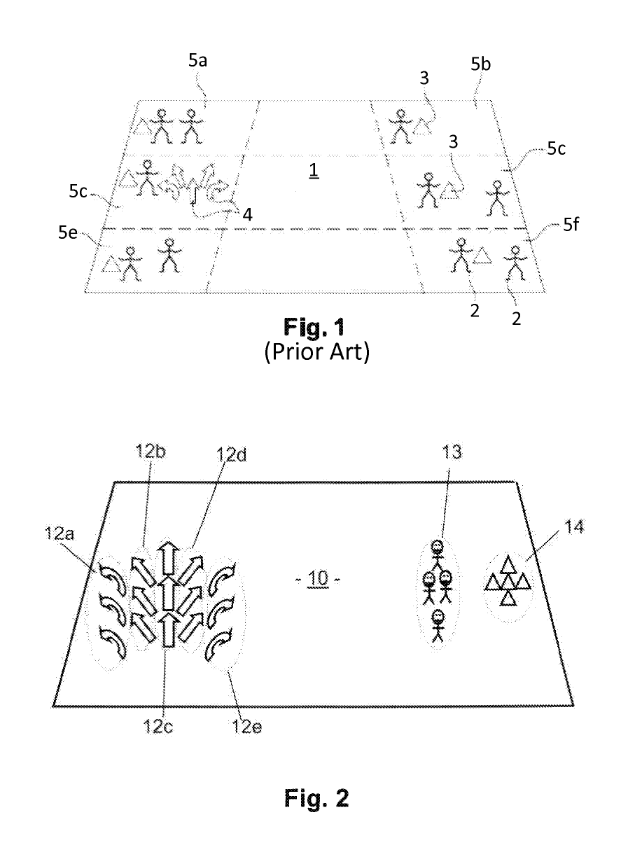

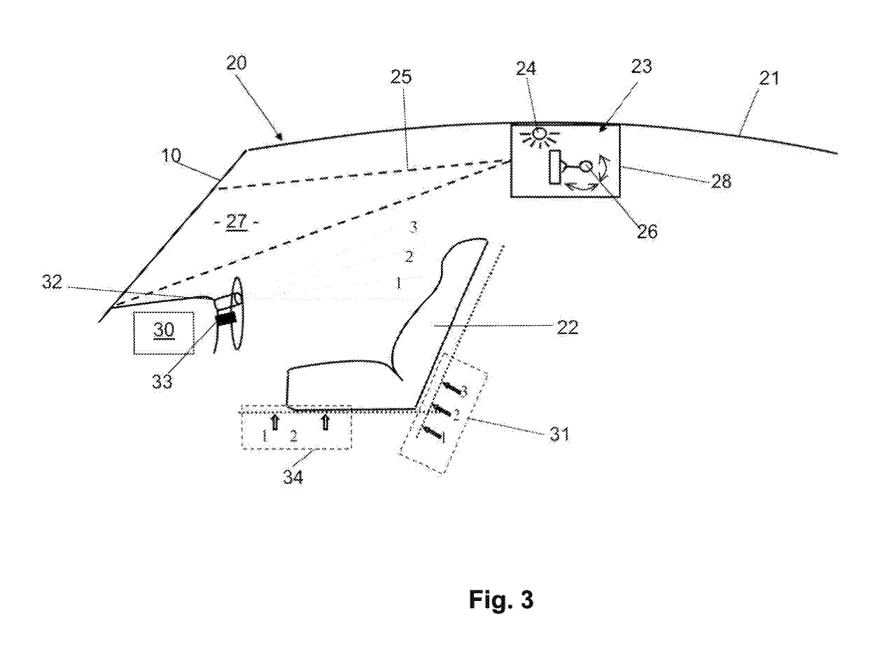

FIG. 2 shows a schematic view of a windshield 10 suitable for a driving assistance system according to various embodiments of the present invention. The windshield 10 of a vehicle 20 (shown in FIG. 3) is covered with a certain number of non-visible visual information, for instance in the form of pictograms 12a-12e, 13 and 14, painted by means of transparent ink sensitive to infrared or ultraviolet light, such as luminophores. These pictograms 12a-12e, 13 and 14 can be arranged over the whole surface of the windshield 10 and, more precisely, are positioned in predefined locations corresponding advantageously with different ocular view points of the driver depending on whether the driver is tall, average height, or short.

Several types of possible alerts can be listed for the representation of the pictograms 12a-12e, 13 and 14, among which pedestrian type pictograms 13 for night vision alert functions with detection, triangle type pictograms 14 for intersection and roundabouts alerts, arrow type pictograms 12a-12e for changes in direction, etc. The different pictograms 12a-12e, 13 and 14 can be printed with different color ink, for instance, to distinguish between alert messages and direction indications. The pictograms 12a-12e, 13 and 14 can be composed starting from a layer of luminophores sensitive to infrareds or sensitive to UV. A device that activates the luminophores is associated in each case. For instance, a set of pictograms can be printed on the front face of the PET sheet inserted in a layered windshield 10.

In order for the driver to see the desired information on the windshield 10, without diverting his eyes from the road scene, it is important that the information is displayed in correspondence with the ocular point of the driver, regardless of the driver's size. For this purpose, the available visual information is regrouped in information groups each comprising several identical pictograms arranged in different predefined locations so that the illumination can be commanded of the desired pictogram, which corresponds with the ocular point of the driver.

For example, as illustrated in FIG. 2, the pictograms of groups 12a-12e can contain directional arrows that indicate to the driver the direction to be followed. To this end, these indications are located in the zone of the windshield situated in front of the driver's seat 22. Depending on the size of the driver and the desired information to be displayed, the arrow is illuminated of one of the groups situated in correspondence with the ocular point of the driver detected by a detection unit 32 provided for this purpose. For instance, for a small person information to turn left will be indicated by illuminating the bottom arrow of group 12a. For a tall person, information to continue straight ahead will be indicated by illuminating the upper arrow of the group 12c, etc. Advantageously, the groups 12a-12e comprise an upper pictogram positioned at the 95th percentile of the ocular point of the driver, a median pictogram positioned at the 50th percentile and a lower pictogram positioned at the 5th percentile. In this manner, none of the identical pictograms of the same group 12a-12e is overlapping, which ensures good legibility of the information for the driver.

FIG. 2 also shows information groups that are decentralized relative to the vision axis of the driver. For instance, group 13 comprises several pictograms representing pedestrians used to alert the driver of the unexpected appearance of an obstacle. For this purpose, a sensor can be provided on the vehicle 20 for detecting obstacles situated in the vision field of the driver and for providing directional information of the detected obstacle to the direction control mechanism of the lighting device.

In order to prevent parallax problems that can occur when the displayed information is decentralized, group 13 comprises at least two horizontally aligned pictograms so that one or the other is illuminated, specifically as a function of the forward/backward adjustment of the seat 22. For instance, if the seat 22 is in retracted position, the pedestrian located the most to the right will be illuminated, while if the seat 22 is in a forward position, the left pedestrian will be illuminated. Since parallax problems are less bothersome for alerts situated low and high on the windshield, it is not necessary to double the related pictograms.

FIG. 3 is a schematic cross section of the cabin of the automotive vehicle 20 equipped with a driving assistance system according to various implementations of the invention. The vehicle 20 is schematically represented by a roof 21, the windshield 10 and the driver's seat 22.

In addition to the visual information, painted by means of invisible ink and supported by the windshield 10, the driving assistance system comprises a lighting device 23 to illuminate the windshield 10 and more in particular the predefined locations where the pictograms are displayed so that they will appear in the vision field of the driver. For this purpose, the lighting device 23 can comprise, for instance, a light source 24 emitting an infrared light beam 25 and a directional control mechanism 26 of the light beam, so that the light beam 25 can cover a sweeping zone 27 extending over the whole windshield 10, and more particularly illuminating each predefined location at a unique predefined angle so that the corresponding visual information or pictogram appears. The directional control mechanism 26 of the light beam 25, ensuring the desired sweeping, can be created by a rotating screen or a set of rotating mirrors (not shown), as already used in certain barcode reading systems for supermarket cash registers or head-up vision systems with laser beam. Alternatively, the sweeping beam 25 can be obtained directly by a displacement mechanism for the orientation of the light source 24. The light beam 25 emitted by the light source 24 is controlled, e.g., turned on and off, in a synchronized manner according to the pictogram(s) to be illuminated. Furthermore, the power of the light source 24 is adapted to the number of pictograms to be illuminated and consequently to the total surface to be swept. For this purpose, the light source 24 is structured and operable to be modulated. The lighting device 23 is installed in a projection housing 28 of the light beam 25, which can be positioned on the roof 21 in order to reach all the points of the windshield 10 without encountering any obstacles inside the vehicle 20. This kind of solution proves to be more interesting than the conventional solutions aimed at arranging the lighting device on the dashboard.

In various embodiments, the driving assistance system further comprises a detection unit 30 for the ocular point of the driver, providing directional information to the lighting device 23, which is adjusted to illuminate, according to the received directional information, the predefined location of the desired information of one of the groups 12a-12e, 13 and 14, situated in correspondence with the detected ocular point of the driver.

For example, in various implementations, the ocular point detection unit 30 supplies directional information based on the height adjustment 31 of the driver's seat 22. If the seat adjustment mechanism 31 is in a low position “position 1”, this means that the driver is tall and therefore the detection unit 30 transmits this information to the lighting device 23 which will illuminate the upper pictogram of the group of selected pictograms 12a-12e, 13 and 14, for instance through the navigation system of the vehicle 20. If the seat adjustment 31 is in an intermediate position, “position 2”, this means that the driver is of average size, e.g., medium height, and therefore the detection unit 30 transmits this information to the lighting device 23, which will illuminate the median pictogram of the group of selected pictograms 12a-12e, 13 and 14. Finally, if the seat adjustment 31 is in a high position “position 3”, this means that the driver is of small size, e.g., short, and therefore the detection unit 30 transmits this information to the lighting device 23, which will illuminate the lower pictogram of the group of selected pictograms 12a-12e, 13 and 14.

In various other embodiments, the detection unit 30 of the ocular point of the driver comprises a camera 32 for detecting the ocular point of the driver on the basis of an image taken by the camera 32. The camera 32 is advantageously arranged in the upper part of a steering column 33 of the vehicle 20 in order not to hinder the vision field of the driver. The image seen by the camera 32 can be processed in relatively simple manner by detecting the presence of the eyes in three zones 1, 2 and 3 corresponding with the three main height categories of drivers, namely small/short, median/medium height and tall.

In yet other embodiments, the detection unit 30 of the ocular point can transmit right or left directional information based on the forward/backward seat adjustment 34, as the seat 22 is forward (position 1) or retracted (position 2). In essence, the forward/backward seat adjustment mechanism 34 is useful for pictograms that are decentralized relative to the driver.

It is understood that various modifications and/or improvements, evident for a person skilled in the art, can be made to the different embodiments described in the present description without exceeding the scope of the invention defined by the attached claims. In particular, the technical goal is to use the whole surface of the windshield 10 to display indications or alerts in correspondence with the eyes of the driver. To this end, the pictograms 12a-12e, 13 and 14 can be printed during the fabrication of the windshield 10 prior to gluing between glass sheets and PVB. The number of pictograms has no impact on the cost. From cost viewpoint, the pictograms require a supplementary step in the fabrication process of the windshield 10, but do not require supplementary components.

What is claimed is:

1-11. (canceled)

12. A driving assistance system incorporated in a vehicle including a windscreen, said system comprising:
non-visible, visual information, arranged in several predefined locations on the windscreen, the visual information comprising at least one first group of identical information;
a lighting device suitable for illuminating each of the predefined locations in order to display the corresponding visual information in the vision field of the driver; and
a detection unit of the ocular point of the driver structured and operable to supply directional information to the lighting device, whereby the lighting device is adjusted to illuminate, according to the received directional information, the predefined location of information of the first group, situated in correspondence with the detected ocular point of the driver.

13. The driving assistance system according to claim 12, wherein the first group comprises at least two identical visual pieces of information arranged one above the other.

14. The driving assistance system according to claim 13, wherein the first group comprises at least three pictograms comprising an upper pictogram, a median pictogram and a lower pictogram, arranged one above the other.

15. The driving assistance system according to claim 14, wherein the detection unit of the ocular point of the driver supplies high, median or low directional information, while the lighting device illuminates respectively the upper, median or lower pictogram.

16. The driving assistance system according to claim 15, wherein the upper pictogram is positioned at the 95th percentile of the ocular point of the driver, the median pictogram is positioned at the 50th percentile of the ocular point of the driver and the lower pictogram is positioned at the 5th percentile of the ocular point of the driver.

17. The driving assistance system according to claim 16, wherein the detection unit of the ocular point of the driver supplies directional information based on a height adjustment of a driver's seat of the vehicle.

18. The driving assistance system according to claim 17, wherein the detection unit of the ocular point of the driver comprises a camera for detecting the ocular point of the driver on the basis of an image taken by the camera.

19. The driving assistance system according to claim 18, wherein the camera is arranged in the upper part of a steering column of the vehicle.

20. The driving assistance system according to one of claims 19, wherein the detection unit of the ocular point supplies one of left and right directional information based on a forward/backward adjustment of the driver's seat.

21. The driving assistance system according to claim 20, wherein the visual information comprises a second group of information decentralized on the windscreen comprising at least two pictograms on the same horizontal line, whereby the lighting device illuminates the pictogram corresponding with the received right or left directional information.

22. An automotive vehicle, said vehicle comprising:
a driving assistance system comprising:
non-visible, visual information, arranged in several predefined locations on the windscreen, the visual information comprising at least one first group of identical information;
a lighting device suitable for illuminating each of the predefined locations in order to display the corresponding visual information in the vision field of the driver; and
a detection unit of the ocular point of the driver structured and operable to supply directional information to the lighting device, whereby the lighting device is adjusted to illuminate, according to the received directional information, the predefined location of information of the first group, situated in correspondence with the detected ocular point of the driver.
